(19) United States
(12) Patent Application Publication
(10) Pub. No.: US 2026/0301456 A1
(43) Pub. Date: Oct. 1, 2026

(54) ITEM TAG PROCESSING SYSTEM AND METHOD

(71) Applicant: DoorDash, Inc., San Francisco, CA (US)

(72) Inventors: Weiyu Zhou, Bellevue, WA (US); Sarah Olsen, Brooklyn, NY (US); Mohammed Arshad Siddiqui, Bengaluru (IN)

(73) Assignee: DoorDash, Inc., San Francisco, CA (US)

(21) Appl. No.: 19/250,782

(22) Filed: Jun. 26, 2025

Related U.S. Application Data
(60) Provisional application No. 63/778,920, filed on Mar. 27, 2025.

(51) Int. Cl. G06V 30/224; G06Q 10/087; G06T 5/30; G06V 30/16; G06V 30/162

(52) U.S. Cl. CPC G06V 30/2247; G06Q 10/087; G06T 5/30; G06V 30/1607; G06V 30/162

(57) ABSTRACT

A method includes a computer receiving image data of an image of a shelf unit with specific items and item tags comprising machine readable codes adjacent to the specific items. The computer identifies the item tags in the image data. The computer identifies machine readable codes in one or more item tags in the image data. The computer resizes the machine readable codes in the image data so that the machine readable codes are a same size. The computer thresholds each pixel in the machine readable codes. After thresholding, the computer performs a morphological operation on the machine readable codes. After performing the morphological operation, the computer adjusts sizes of features of the machine readable codes. After adjusting sizes, the computer outputs modified machine readable codes.

### CROSS-REFERENCES TO RELATED APPLICATIONS

This application claims the benefit of U.S. Provisional Application No. 63/778,920, filed Mar. 27, 2025, which is herein incorporated by reference in its entirety for all purposes.

### SUMMARY

One embodiment is related to a method comprising: receiving, by a computer, image data of an image of a shelf unit with specific items and item tags comprising machine readable codes adjacent to the specific items; identifying, by the computer, the item tags in the image data; identifying, by the computer, machine readable codes in one or more item tags in the image data; resizing, by the computer, the machine readable codes in the image data so that the machine readable codes are a same size; thresholding, by the computer, each pixel in the machine readable codes; after thresholding, performing, by the computer, a morphological operation on the machine readable codes; after performing the morphological operation, adjusting, by the computer, sizes of features of the machine readable codes; and after adjusting sizes, outputting, by the computer, modified machine readable codes.

Another embodiment is related to a computer comprising: a processor; and a computer-readable medium coupled to the processor, the computer-readable medium comprising code executable by the processor for implementing a method comprising: receiving image data of an image of a shelf unit with specific items and item tags comprising machine readable codes adjacent to the specific items; identifying the item tags in the image data; identifying machine readable codes in one or more item tags in the image data; resizing the machine readable codes in the image data so that the machine readable codes are a same size; thresholding each pixel in the machine readable codes; after thresholding, performing a morphological operation on the machine readable codes; after performing the morphological operation, adjusting sizes of features of the machine readable codes; and after adjusting sizes, outputting modified machine readable codes.

Another embodiment is related to a method comprising: receiving, by a server computer from a user device, image data of an image of a shelf unit with specific items and item tags comprising machine readable codes adjacent to the specific items; storing, by the server computer, the image data in an image database, wherein an image analysis computer obtains the image data from the image database, identifies the item tags in the image data, identifies machine readable codes in one or more item tags in the image data, thresholds each pixel in the machine readable codes, performs a morphological operation on the machine readable codes, adjusts sizes of features of the machine readable codes, determines modified machine readable codes, and stores the modified machine readable codes in an item information database; obtaining, by the server computer, the modified machine readable codes from the item information database; and updating, by the server computer, an application maintained by the server computer using the modified machine readable codes.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a computer according to embodiments.

FIG. 3 shows a flowchart illustrating a machine readable code modification method according to embodiments.

FIG. 4 shows an image of item tags according to embodiments.

FIG. 5 shows images illustrating item tag segmentation and rectification according to embodiments.

FIG. 6 shows an image illustrating machine readable code detection according to embodiments.

FIG. 7 shows images illustrating example morphological operations according to embodiments.

FIG. 8 shows images illustrating machine readable code reconstruction according to embodiments.

FIG. 9 shows a block diagram illustrating a delivery system according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor, and a computer-readable medium coupled to the processor, the computer-readable medium comprising code, executable by the processor. The user device may also include an external communication interface for communicating with each other and other entities. Examples of user devices may include mobile devices (e.g., a mobile phone), laptop or desktop computers, wearable devices (e.g., smartwatch), etc.

“Image data” can include information related to a visible impression obtained by a camera, telescope, microscope, or other device, or displayed on a display device such as a computer screen or a video screen. Image data can include a plurality of pixels, where each pixel can include data that indicates how that pixel is displayed (e.g., a color value, etc.).

A “shelf unit” can include a surfaces upon which items can be displayed. A shelf unit can include horizontal shelves, gondola shelves, wire rack shelves, etc. A shelf unit can display a plurality of items and item tags that relate to the items.

An “item tag” can include a label that includes information about an item. An item tag can include a machine readable code (e.g., a barcode, a QR code, etc.), a price, SKU codes, and/or other information that describes the related item printed or otherwise displayed on a substrate such as a paper substrate.

A “barcode” can include a machine-readable code that includes a plurality of bars. A barcode can be in the form of numbers and a pattern of parallel lines of varying widths (e.g., bars). A barcode can correspond to and identify a specific item.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Managing inventory is a time-consuming and challenging process for service providers. Most service providers (e.g., retail merchants such as grocery stores) are only able to infrequently count their inventory, such as between once per week and once per month. The difficulties compound when the service provider shares information (e.g., through advertising) regarding what items are actually available at the service provider location.

Currently, employees of resource providers can use handheld barcode scanners to scan individual item tags on shelves to first identify the items on shelves. The resource providers can place the handheld barcode scanner close (e.g., a few inches) to the item tag to scan the single item tag. Scanning the item tag can allow the handheld barcode scanner to identify the one item associated with the one scanned item tag. The scanning process can be slow since employees need to individually scan many item tags in a store. Further, the process is error prone as it can be difficult to remember which item tags have been scanned and which have not been scanned.

With this in mind, it can take a long time for a service provider to update their inventory system to accurately identify the items on the shelves at the service provider. It can also take a long time to determine whether or not the items associated with shelf tags are present and in what quantity the items are present on the shelves. Subsequent information updates about the availability of items at a service provider to external parties such as delivery organizations would also be delayed.

In embodiments of the invention, computer vision techniques can be used to scan the items on the shelves. An image detection model can be usually trained on a golden dataset (e.g., a single, authoritative source of data) to identify the SKUs (stock keeping units) from store shelf images. Previous computer vision approaches can have low accuracy.

Embodiments of the disclosure address these problem and other problems individually and collectively.

Embodiments of the disclosure allow user devices to capture image data of shelf unit(s) such that the image data can be analyzed and modified by a computer to extract machine readable code data from the image data. The computer can determine data about what is on the shelf unit based on the machine readable code data that is determined using the image data.

In embodiments of the invention, an image analysis computer can obtain image data from an image of a shelf unit with specific items and item tags. The item tags can comprise machine readable codes adjacent to the specific items. The image analysis computer can then pre-process the image data. The pre-processed image data is optimized so that a machine learning model can accurately read and identify the machine readable codes. In contrast, inputting raw image data of machine readable codes into a machine learning model may result in inaccurate identifications or no identifications at all.

In embodiments of the invention, an image analysis computer can first identify the item tags in image data from an image. It can then read and identify machine readable codes in one or more of the item tags in the image data using a machine learning model. The image analysis computer can pre-process or modify the machine readable codes to make them more readable by the machine learning model or another machine learning model. As an illustration, the image analysis computer can resize the machine readable codes in the image data so that the machine readable codes are a same size. The image analysis computer can threshold each pixel (e.g., to a value of 0 or 1) in the machine readable codes. After thresholding, the image analysis computer can perform a morphological operation on the machine readable codes. The image analysis computer can then adjust sizes of features of the machine readable codes. After adjusting sizes, the image analysis computer can output modified machine readable codes that are suitable for input into a machine learning model.

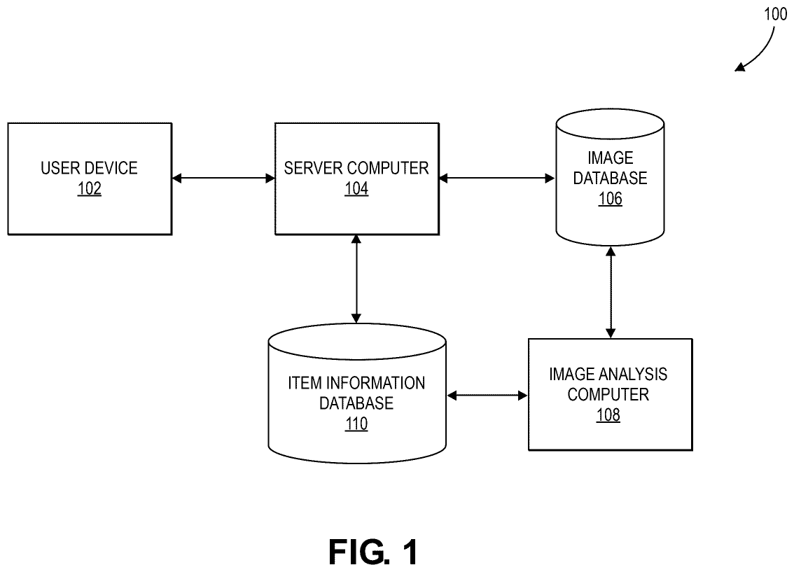

FIG. 1 shows a system 100 according to embodiments of the disclosure. The system 100 comprises a user device 102, a server computer 104, an image database 106, an image analysis computer 108, and an item information database 110.

The user device 102 can be in operative communication with the server computer 104. The server computer 104 can be in operative communication with the image database 106 and the item information database 110. The image analysis computer 108 can be in operative communication with the image database 106 and the item information database 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between devices in the system 100 illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include an end user device operated by a user, such as a smartphone, a tablet, a smart wearable device, etc. The user device 102 can include a camera that can capture image data of an image. The user device 102 can provide image data for one or more images to the server computer 104.

For example, the user device 102 can capture image data of an image of a shelf unit with specific items and item tags comprising machine readable codes adjacent to the specific items. The user device 102 can provide the image data to the server computer 104. In some embodiments, the user device 102 can capture a plurality of image data and can provide the plurality of image data to the server computer 104.

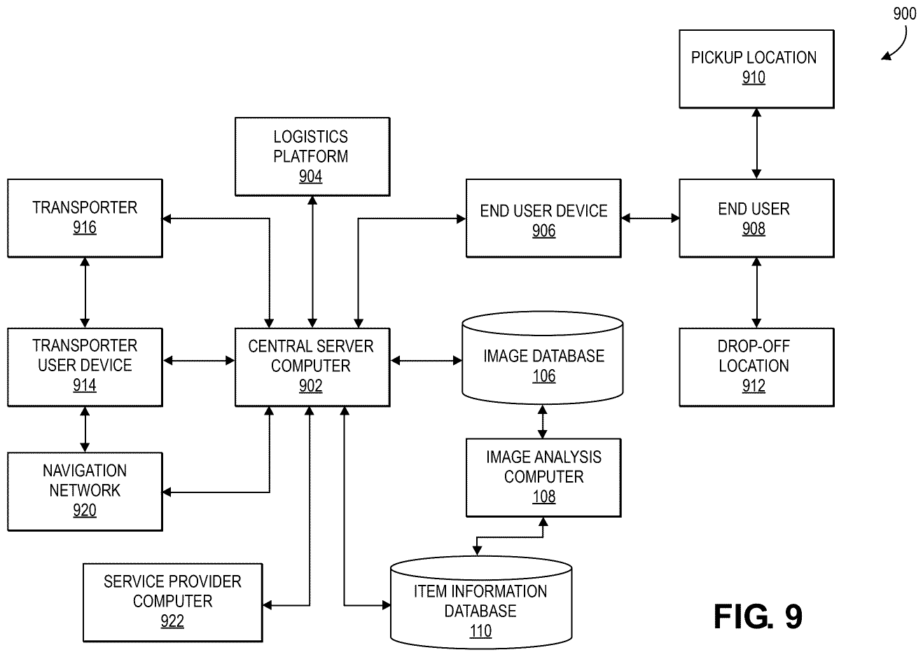

The server computer 104 can be a central server computer 902 such as the one illustrated in FIG. 9. The server computer 104 can communicate with a plurality of user devices (e.g., including the user device 102) to obtain image data. The server computer 104 can store received image data into the image database 106.

The image database 106 can store image data. The image database 106 can store image data in association with resource provider identifiers, user device identifiers, shelf unit identifiers, or any other identifiers that can link the image data to devices involved in the capturing of the image data, to the location of the image data, and/or to information related to the contents of the image data. For example, the image database 106 can store information that relates the image data other data. For example, the image database 106 can store the image data in association with a service provider location, a service provider identifier, a service provider location identifier, an aisle number, user device orientation data, image metadata, and/or other data.

The image analysis computer 108 can be a laptop computer, a desktop computer, a server computer, etc. The image analysis computer 108 can be configured to process image data. The image analysis computer 108 can obtain image data from the image database 106. The image analysis computer 108 can analyze the image data.

The image analysis computer 108 can analyze the image data to determine one or more machine readable codes in the image data. For example, the image analysis computer 108 can identify item tags in the image data. The image analysis computer 108 can then modify the item tags in the image data and can identify machine readable codes in the item tags. The image analysis computer 108 can then modify the machine readable codes, and output modified machine readable codes. The modified machine readable codes can be images of machine readable codes that are modified to be more accurately readable by a machine.

The item information database 110 can store modified image data. For example, the item information database 110 can store the output modified machine readable codes. The item information database 110 can store modified machine readable codes in association with item identifiers, resource provider identifiers, user device identifiers, or other data that can identify things that are related to the modified machine readable codes.

The image database 106 and the item information database 110 can include any suitable databases. The databases may be conventional, fault tolerant, relational, scalable, secure databases such as those commercially available from Oracle™ or Sybase™.

The server computer 104 can obtain modified machine readable codes from the item information database 110. The server computer 104 can update an application maintained by the server computer 104 based on the modified machine readable codes.

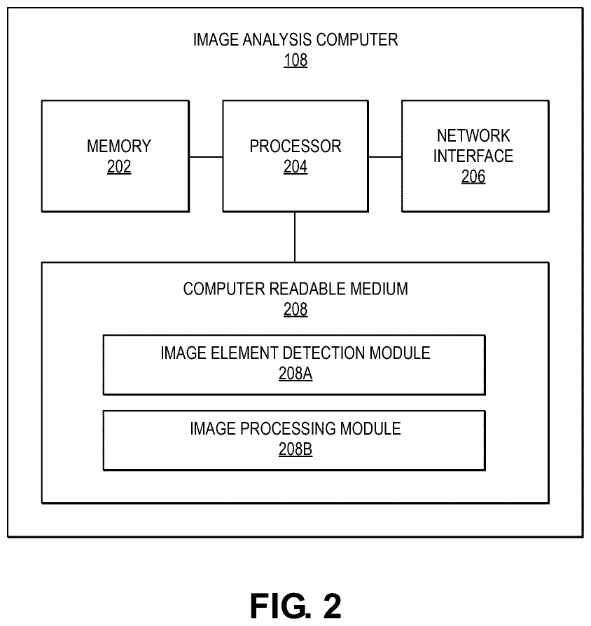

FIG. 2 shows a block diagram of an image analysis computer 108 according to embodiments. The exemplary image analysis computer 108 may comprise a processor 204. The processor 204 may be coupled to a memory 202, a network interface 206, and a computer readable medium 208. The computer readable medium 208 can include modules. The computer readable medium 208 can include an image element detection module 208A and an image processing module 208B.

The memory 202 can be used to store data and code. For example, the memory 202 can store machine learning model training data, machine learning model weights, image data, machine readable code data, item data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a computer, image data of an image of a shelf unit with specific items and item tags comprising machine readable codes adjacent to the specific items; identifying, by the computer, the item tags in the image data; identifying, by the computer, machine readable codes in one or more item tags in the image data; resizing, by the computer, the machine readable codes in the image data so that the machine readable codes are a same size; thresholding, by the computer, each pixel in the machine readable codes; after thresholding, performing, by the computer, a morphological operation on the machine readable codes; after performing the morphological operation, adjusting, by the computer, sizes of features of the machine readable codes; and after adjusting sizes, outputting, by the computer, modified machine readable codes.

The image element detection module 208A may comprise code or software, executable by the processor 204, for identifying image elements in image data. The image element detection module 208A, in conjunction with the processor 204, can identify image elements, such as item tags, machine readable codes, text, items, etc.

The image element detection module 208A, in conjunction with the processor 204, can identify image elements in image data using a machine learning model. The image element detection module 208A, in conjunction with the processor 204, can train, maintain, and utilize a computer vision (CV) machine learning model to identify item tags and/or barcodes in image data of shelf units. The image element detection module 208A, in conjunction with the processor 204, can utilize a first computer vision machine learning model to identify item tags in the image data and can utilize a second computer vision machine learning model to identify barcodes in item tags. In some embodiments, the first computer vision machine learning model can be the same as the second computer vision machine learning model.

The computer vision machine learning model can be designed to evaluate visual data based on features and contextual information identified during training of the computer vision machine learning model. This training can allow the computer vision machine learning model to interpret images as well as video (e.g., which can be a sequence of images) and apply those interpretations to predictive or decision making tasks.

The computer vision machine learning model can be a convolutional neural network. Convolutional neural networks can be neural networks with a multi-layered architecture that are used to gradually reduce data and calculations to the most relevant set. This most relevant set is then compared against known data (e.g., such as a label) to identify or classify the data input.

When an image is processed by the computer vision machine learning model, each base color used in the image (e.g., red, green, and blue) can represented as a matrix of values. These values are evaluated and condensed into 3D tensors (e.g., in the case of color images), which can be collections of stacks of feature maps tied to a section of the image. These tensors can be created by passing the image through a series of convolutional layers and pooling layers, which are used to extract the most relevant data from an image segment and condense it into a smaller, representative matrix. This process can be repeated numerous times, which can depend on the number of convolutional layers in the architecture. The final features extracted by the convolutional process are sent to a fully connected layer, which can generate predictions.

Computer vision techniques can utilize two different types of object detection: two-step object detection and one-step object detection.

For two-step object detection, the first step can utilize a region proposal network (RPN), which can provide a number of candidate regions that may contain important objects in the image data. The second step can include passing region proposals to a neural classification architecture, commonly a region-based convolutional neural network (RCNN) based hierarchical grouping algorithm, or region of interest (ROI) pooling in a fast RCNN. These approaches are provided for the tradeoff of increased accuracy, but decreased speed.

One-step object detection can be utilized for real-time object detection. One-step object detection architectures can process image data faster than two-step object detection architectures. One-step object detection architectures can include you only look once (YOLO), single shot multibox detector (SSD), and RetinaNet. The one-step object detection architectures combine the detection and classification steps by regressing bounding box predictions. Each determined bounding box can be represented with a few coordinates, making it easier to combine the detection and classification steps and speed up processing. The computer vision machine learning model can utilize one-step object detection.

The image element detection module 208A, in conjunction with the processor 204, can train the computer vision machine learning model (e.g., an item tag identification machine learning model). For example, the image element detection module 208A, in conjunction with the processor 204, can obtain a set of image data from the image database 106. The image element detection module 208A, in conjunction with the processor 204, can apply one or more preprocessing methods to each image data including mirroring, rotating, smoothing, contrast reduction, noise reduction, scaling, rectifying, etc. to create a preprocessed set of image data.

After preprocessing each image data in the set of image data, the image element detection module 208A, in conjunction with the processor 204, can create a first training set comprising the preprocessed set of image data. The image element detection module 208A, in conjunction with the processor 204, can train the computer vision machine learning model in a first training iteration using the first training set.

The image element detection module 208A, in conjunction with the processor 204, can iteratively train the computer vision machine learning model to identify item tags in image data. The image element detection module 208A, in conjunction with the processor 204, can create a second training set for a second training iteration. The image element detection module 208A, in conjunction with the processor 204, can obtain a second set of image data from the image database 106. The image element detection module 208A, in conjunction with the processor 204, can preprocess the image data in the second set of image data to form a second preprocessed set of image data. The image element detection module 208A, in conjunction with the processor 204, can create the second training set using the preprocessed second set of image data from the image database 106. The image element detection module 208A, in conjunction with the processor 204, can train the computer vision machine learning model using the second training set.

During each training iteration, the image element detection module 208A, in conjunction with the processor 204, can optimize a loss function based on values determined during training. The image element detection module 208A, in conjunction with the processor 204, can optimize the loss function to update weights in the computer vision machine learning model.

After training the computer vision machine learning model, the image element detection module 208A, in conjunction with the processor 204, can utilize the computer vision machine learning model during an inference phase. The image element detection module 208A, in conjunction with the processor 204, can perform an item tag detection process using the image data. The item tag detection process can identify the item tags that are included in the image data. The item tag detection process can include a machine learning model that is trained to identify item tags in image data. During the item tag detection process, the image element detection module 208A, in conjunction with the processor 204, can determine a plurality of item tags that include machine readable codes. The image element detection module 208A, in conjunction with the processor 204, can utilize the machine readable code on each item tag as well as other item information on the item tag (e.g., item name, item price, etc.) to obtain item data for the item tag.

The image element detection module 208A, in conjunction with the processor 204, can identify one or more machine readable codes in an item tag. The item tag can be a portion of an image that includes an item tag. The image element detection module 208A, in conjunction with the processor 204, can train a second computer vision machine learning model (e.g., a machine readable code identification machine learning model). For example, the image element detection module 208A, in conjunction with the processor 204, can obtain a set of images of item tags that include machine readable codes. The image element detection module 208A, in conjunction with the processor 204, can apply one or more preprocessing methods to each image. After preprocessing each image of an item tag, the image element detection module 208A, in conjunction with the processor 204, can create a first item tag training set comprising the preprocessed set of images of item tags. The image element detection module 208A, in conjunction with the processor 204, can train the second computer vision machine learning model in a first training iteration using the first item tag training set. The image element detection module 208A, in conjunction with the processor 204, can iteratively train the second computer vision machine learning model to identify machine readable codes in images of item tags.

After training the computer vision machine learning model, the image element detection module 208A, in conjunction with the processor 204, can utilize the second computer vision machine learning model during an inference phase. The image element detection module 208A, in conjunction with the processor 204, can perform a machine readable code detection process using an image of an item tag. The machine readable code detection process can identify a machine readable code that is included in the image of the item tag.

As an illustrative example, the image element detection module 208A, in conjunction with the processor 204, can identify item tags in the image data using a first computer vision machine learning model. After identifying the item tags, the image element detection module 208A, in conjunction with the processor 204, can identify one or more machine readable codes in the item tags in the image data using a second computer vision machine learning model.

The image processing module 208B may comprise code or software, executable by the processor 204, for processing image data. The image processing module 208B, in conjunction with the processor 204, can modify image data. For example, the image processing module 208B, in conjunction with the processor 204, can resize image data, threshold image data pixel values, perform morphological operations on image data, increase the contrast of image data, rectify image data, and perform any other image modification methods.

The image processing module 208B, in conjunction with the processor 204, can resize image data and/or sections of data from the image data. For example, the image processing module 208B, in conjunction with the processor 204, can resize image data of a shelf unit. The image processing module 208B, in conjunction with the processor 204, can also resize a portion of the image data that includes a machine readable code.

The image processing module 208B, in conjunction with the processor 204, can threshold pixel values in image data. For example, the image processing module 208B, in conjunction with the processor 204, can threshold each pixel in image data that includes machine readable code(s). Thresholding pixel values can include segmenting the pixel values (e.g., the value of the pixel on a scale of 0-1) using a step function (or other segmentation method) to further separate the pixel values into two different categories (e.g., black (0) and white (1)).

The image processing module 208B, in conjunction with the processor 204, can perform morphological operations on image data. For example, the image processing module 208B, in conjunction with the processor 204, can adjust sizes of features of the image data (e.g., features of machine readable codes). Morphological operations can include techniques used in image processing that focus on the structure and form of objects within an image. Morphological operations process images based on their shapes and can be applied to binary images and grayscale images. Morphological operations can be utilized to probe an image with a structuring element and modify the pixel values based on their spatial arrangement and the shape of the structuring element. Example morphological operations include erosion, dilation, opening, and closing, where each serves distinct purposes in enhancing and analyzing images.

The image processing module 208B, in conjunction with the processor 204, can perform image rectification. Image rectification can include a transformation process used to project images onto a common image plane. For example, a machine readable code on an image tag may have a normal vector that is not directly pointing at the camera when the image data is captured. The image processing module 208B, in conjunction with the processor 204, can rectify (e.g., skew) an image of a machine readable code, such that the machine readable code appears to be coplanar with the camera.

The network interface 206 may include an interface that can allow the image analysis computer 108 to communicate with external computers. The network interface 206 may enable the image analysis computer 108 to communicate data to and from another device (e.g., the image database 106, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

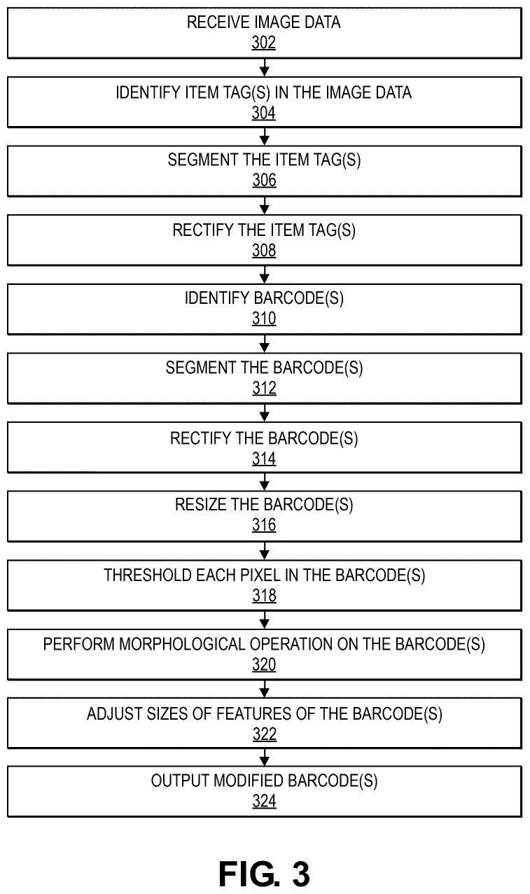

FIG. 3 shows a flowchart of an item tag modification method according to embodiments. The method illustrated in FIG. 3 will be described in the context of a user, who is a transporter, obtaining image data at a resource provider location using the user device 102. The user device 102 can be a transporter user device. The user device 102 provides the image data to the server computer 104, which stores the image data in the image database 106. The image analysis computer 108 then analyzes the image data stored in the image database 106.

For example, prior to step 302, the user device 102 can capture image data using a camera in the user device 102. The image data can include an image of a shelf unit at a service provider location that provides access to items. The shelf unit can have items and item tags on the shelf unit. The user device 102 can provide the image data to the server computer 104.

In some embodiments, the user device 102 can be prompted to capture image data by the server computer 104. For example, the server computer 104 can receive location data from the user device 102. The server computer 104 can determine if the user device 102 is in a location to capture image data of shelf units. The server computer 104 can generate an image data request message that requests the user device 102 to capture image data of one or more shelf units near to the user device 102. The server computer 104 can provide the image data request message to the user device 102. After capturing the image data, the user device 102 can generate an image data response message comprising the image data. The user device 102 can provide the image data response message to the server computer 104.

After receiving the image data from the user device 102, the server computer 104 can store the image data into the image database 106.

At step 302, the image analysis computer 108 can obtain the image data from the image database 106. The image data can include an image of a shelf unit. The shelf unit can include specific items and item tags. The item tags can include machine readable codes and other information such as text. The item tags can be adjacent to the specific items. The items can be resources that are provided by the service provider to end users. The shelf unit, for example, can include shelving in an aisle at the service provider location.

At step 304, after obtaining the image data, the image analysis computer 108 can identify item tags in the image data. The image analysis computer 108 can identify the item tags using a machine learning model, which can be a computer vision machine learning model.

The computer vision machine learning model can include a you only look once (YOLO) machine learning model to identify the item tags. A you only look once model can be a single-shot detector that uses a fully convolutional neural network (CNN) to process image data. Further details regarding you only look once models can be found in “You Only Look Once: Unified, Real-Time Object Detection” by J Redmon et al. 2015 (Arxiv reference arXiv: 1506.02640 [cs. CV]), which is herein incorporated by reference.

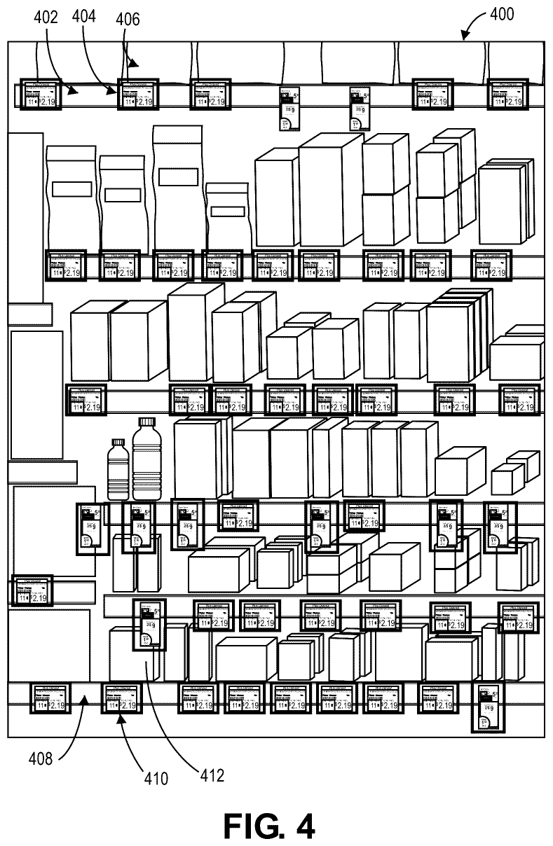

As an illustrative example, FIG. 4 shows an image of item tags according to embodiments. The item tags can be identified in the image data using the machine learning model. The machine learning model can be trained on image data that includes images of items and item tags on shelf units.

FIG. 4 includes an image 400 that includes a first shelf 402 of the shelf unit, a first item tag bounding box 404, a first item 406, second shelf 408, a second item tag bounding box 410, and a second item 412.

The first shelf 402 and the second shelf 408 can be shelves on the shelf unit in the image data. Each shelf can hold a plurality of items and can have a plurality of item tags on the shelf. The plurality of items can correspond to the plurality of item tags. In some embodiments, each item on the shelf unit can correspond to one item tag. In other embodiments, each item tag can on the shelf unit can correspond to one or more items.

The first item tag bounding box 404 and the second item tag bounding box 410 can be identified using the machine learning model (e.g., an item tag identification machine learning model. The first item tag bounding box 404 can correspond to the first item 406 on the first shelf 402. The second item tag bounding box 410 can correspond to the second item 412 on the second shelf 408. For example, the first item tag bounding box 404 can correspond to the first item 406 based on the shelf unit layout, the first shelf 402, and the proximity of the first item tag bounding box 404 in the image 400.

The first item tag bounding box 404 and the second item tag bounding box 410 can indicate regions in the image 400 that include an item tag. For example, the first item tag bounding box 404 can include a first item tag. The second item tag bounding box 410 can include a second item tag.

The image analysis computer 108 can utilize the machine learning model to identify a plurality of regions of the image data that correspond to a plurality of item tags. In some embodiments, the plurality of regions can be indicated by bounding boxes in the image data. A region can be a number of pixels in the image data. In some embodiments, a region can include the item tag and may or may not include pixels that are within the bounding box, but are not the item tag. The image analysis computer 108 can control the size of the bounding boxes that are determined using the machine learning model.

Returning to FIG. 3, at step 306, the image analysis computer 108 can segment the item tag bounding boxes from the image data. For example, the image analysis computer 108 can create a smaller image of an item tag from each of the item tag bounding boxes.

In some embodiments, the image analysis computer 108 can identify and then segment the item tags in the image data using the machine learning model. The machine learning model can both identify the item tags and output images that include the item tags. The images that include the item tags can be portions of the image data. As an example, the machine learning model can be a segmentation model can be trained on 1000 tags with a U2 net model for salient object detection. Such a segmentation model, according to embodiments, can have a 99.7% accuracy.

At step 308, after identifying the item tags in the image, the image analysis computer 108 can rectify each item tag (e.g., each image of an item tag). The image analysis computer 108 can rectify each item tag such that the item tag is aligned vertically. For example, image rectification with skew correction involves correcting an image that is not aligned perfectly horizontally or vertically (e.g., due to camera angle or document skewing). The rectification process can involve rotating the image to straighten the skewed lines and edges, ensuring that they are parallel to the horizontal and vertical axes.

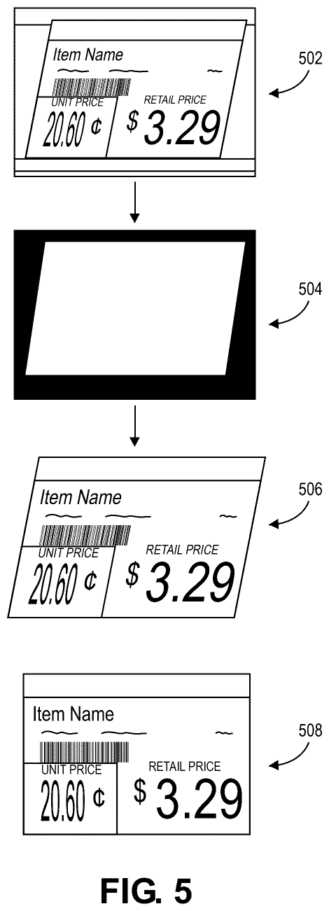

As an illustrative example, the image analysis computer 108 can perform an item tag and segmentation rectification process as described in reference to FIG. 5. FIG. 5 shows images illustrating item tag segmentation and rectification according to embodiments. FIG. 5 includes an image of an item tag 502, a mask 504, a masked item tag 506, and a rectified item tag 508.

The image of the item tag 502 can include the region of the image data as identified by the first item tag bounding box 404 of FIG. 4. The image of the item tag 502 can include a subset of pixels of the overall image data.

The image analysis computer 108 can segment the region of the image of the item tag 502 from the image data to obtain an image that includes the identified image tag as identified by the first item tag bounding box 404. As such, the image of the item tag 502 can be separated into a different image from the image data that includes the shelf unit. By separating the image of the item tag 502 from the image data, the image analysis computer 108 can rectify the image of the item tag 502 rather than rectifying the whole of the image data.

After segmenting the image of the item tag 502 from the image data, the image analysis computer 108 can determine the mask 504 that indicates the boundaries of the image of the item tag 502. In some embodiments, the mask 504 can also be output from the machine learning model that identifies the item tags in the image. For example, the machine learning model can identify the item tag and can output the image of the item tag 502 that includes the pixels bounded by the first item tag bounding box 404 in the overall image data as well as the mask 504 that identifies the item tag in the image of the item tag 502.

In some embodiments, the image analysis computer 108 can generate the mask 504. The image analysis computer 108 can generate the mask 504 using one or more image processing techniques including, but not limited to, alpha mask thresholding (e.g., setting pixel values above or below a certain threshold to create a binary mask), edge detection (e.g., identifying edges in the image to create a mask highlighting object boundaries), color-based segmentation (e.g., isolating regions based on color information), and deep learning (e.g., training a neural network to predict pixel-wise segmentation masks).

After obtaining the image of the item tag 502 and the mask 504, the image analysis computer 108 can apply the mask 504 to the image of the item tag 502 to determine the masked item tag 506.

After determining the masked item tag 506, the image analysis computer 108 can rectify the masked item tag 506 to determine the rectified item tag 508. The image analysis computer 108 can rectify the masked item tag 506 using a rectification algorithm. The image analysis computer 108 can rectify the masked item tag 506 by modifying the masked item tag 506 in such a manner that the borders of the masked item tag 506 are altered from being diagonal to being on a horizontal axis and a vertical axis.

In some embodiments, the rectification algorithm can read the output mask from the segmentation model and compute a contour of the item tag. The image analysis computer 108 can perform a perspective transform to skew the masked item tag 506 into a rectangular shape that has 90 degree angles. For example, the image analysis computer 108 can skew the item tag using OpenCV methods. As such, the image analysis computer 108 can rectify the masked item tag 506 into the rectified item tag 508. The image analysis computer 108 can rectify the skew of the image data using a matrix transformation to compensate for roll, pitch, and yaw differences between a plane of the camera and a plane of the item tag.

Returning to FIG. 3, at step 310, after rectifying the item tag, the image analysis computer 108 can detect a machine readable code in the item tag. The image analysis computer 108 can detect the machine readable code in the item tag using a second machine learning model. The second machine learning model can be the same as the aforementioned machine learning model or can be a different machine learning model. For example, the image analysis computer 108 can identify a machine readable code in a rectified image of an item tag using a machine readable code identification machine learning model.

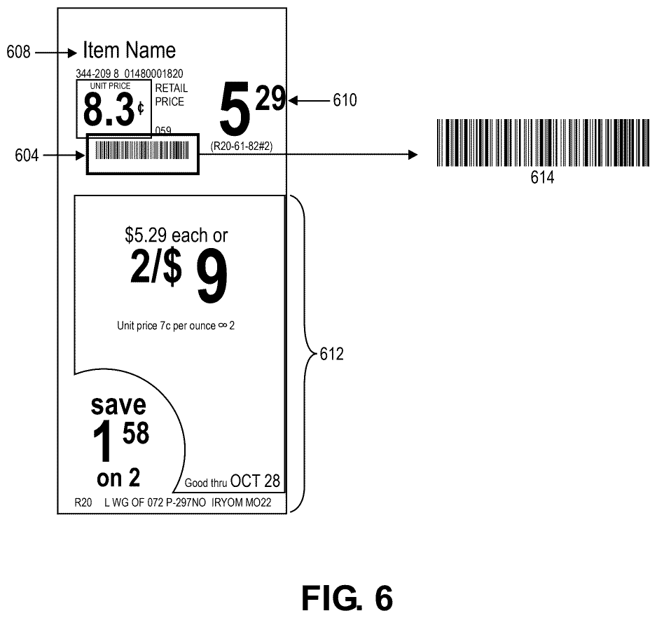

At step 312, after identifying a machine readable code in the item tag, the image analysis computer 108 can segment the machine readable code from the image of the item tag. The segmentation process for the machine readable codes can be similar to the segmentation process for the item tags. FIG. 6 illustrates an example rectified item tag and segmented machine readable code.

FIG. 6 shows an image illustrating machine readable code detection according to embodiments. FIG. 6 illustrates a rectified item tag 602, which can be the same as the rectified item tag 508. The rectified item tag 602 can include a machine readable code 604. The rectified item tag 602 can include further information such as an item name 608, an item price 610, and temporary information 612. FIG. 6 also includes a segmented machine readable code 614.

The item name 608 can include alphanumeric characters that can identify an item associated with the rectified item tag 602. The item price 610 can indicate an amount associated with the item. The temporary information 612 can include information that is transitory and only related to the item at certain points in time. For example, the temporary information can include information about a discount for the item.

The image analysis computer 108 can identify the machine readable code 604 in the item tag 602. The image analysis computer 108 can identify the machine readable code 604 using a machine learning model. The machine learning model can be a you only look once (YOLO) model (e.g., YOLOV5). The machine learning model can be pre-trained on images of item tags that include machine readable codes. The machine learning model can be trained to identify machine readable code in the item tags.

The image analysis computer 108 can identify the machine readable code 604 in the rectified item tag 602 and can segment the machine readable code 604 from the rectified item tag 602 to obtain the segmented machine readable code 614.

In some embodiments, the image analysis computer 108 can further modify any of the images (e.g., the image of the shelf unit, the image of the item tag, an image of the machine readable code, etc.). The image analysis computer 108 can perform adjustments the image's curve tone, contrast, sharpening amount, white balance, etc. The image analysis computer 108 can also perform 16-bit raw image processing, denoising, etc.

Returning to FIG. 3, at step 314, the image analysis computer 108 can rectify the machine readable code that is segmented from the item tag. In some embodiments, the machine readable code may be skewed at an angle compared to the overall shape of the item tag on the shelf unit compared to the plane of the camera. For example, the item tag may be curved and can be rectified in step 308. However, information printed on the item tag may still be skewed in the rectified item tag. As such, after segmenting the machine readable code from the rectified item tag, the image analysis computer 108 can rectify the machine readable code.

At step 316, after obtaining the segmented and rectified machine readable code(s), the image analysis computer 108 can resize one or more of the machine readable codes. The image analysis computer 108 can resize each machine readable code in the image data such that the machine readable codes are a same size. The image analysis computer 108 can resize each machine readable code to a predetermined size. The image analysis computer 108 can resize the machine readable codes in the image data to a predetermined pixel height and a predetermined pixel width. For example, the image analysis computer 108 can resize each machine readable code to a size with a width of 500 pixels, 700 pixels, 1000 pixels, etc. and a height of 50 pixels, 200 pixels, 500 pixels, etc.

At step 318, after resizing the machine readable code, the image analysis computer 108 can threshold each pixel in the machine readable codes. For every pixel in the image of the machine readable code, the image analysis computer 108 can apply a same threshold value (e.g., 0.2, 0.5, 0.7, 0.9, etc. for values on a scale from 0-1). If the pixel value is smaller than the threshold, the pixel value is set to a minimum value (e.g., 0), otherwise the pixel value is set to a maximum value (e.g., 1). For example, the image analysis computer 108 can apply a step function to apply a threshold value to separate high value pixels from low value pixels.

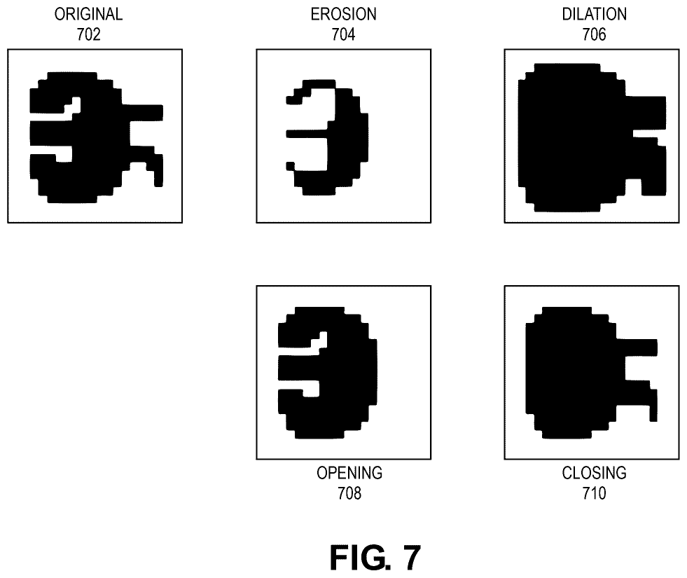

At step 320, after thresholding the pixels, the image analysis computer 108 can perform one or more morphological operations on the machine readable code. The image analysis computer 108 can perform one or more morphological operations on the machine readable codes. Further details about morphological operations are described in reference to FIG. 7, below. As an example, the image analysis computer 108 can perform an erosion morphological operation and can then perform a dilation morphological operation on the machine readable codes.

In some embodiments, the image analysis computer 108 can remove small sections of extraneous information (e.g., blobs of pixels) from the machine readable code. The image analysis computer 108 can find the area of a contour (e.g., a region of pixel with a value of 0-black) in the image of the machine readable code. The image analysis computer 108 can filter by a minimum width (e.g., 10 pixels, 40 pixels, 65 pixels, etc.) and can remove sections of extraneous information that are smaller than the minimum width. The image analysis computer 108 can also remove extraneous information from the edges of the image of the machine readable code. For example, the image analysis computer 108 can set any pixels within a set distance from the left and right sides of the image of the machine readable code to have a value of 1 (e.g., set to white).

At step 322, after performing the morphological operations, the image analysis computer 108 can adjust the sizes of features of the machine readable code. The features of the machine readable code can include the bars of barcodes, pixel sizes of QR codes, etc.

For example, in some embodiments, when the machine readable code is a barcode, the image analysis computer 108 can adjust the height of each bar of the machine readable code to be a predetermined height (e.g., 80% of the height of the image, 90% of the height of the image, 100% of the height of the image, etc.).

In some embodiments, the image analysis computer 108 can find the largest contour groups in the image. A contour group can be a continuous region of black pixels (e.g., such as a bar in a barcode). The image analysis computer 108 can sort the contours by their bounding rectangle height in descending order (e.g., in order of height). The image analysis computer 108 can determine a set of 4, 6, 10, 15, etc. contours with the largest heights. The image analysis computer 108 can calculate a y-range (e.g., a range that indicates the pixel row of the barcode at the lowest and highest points along the y axis) and height of each of the largest contours and group the contours based on the y-range. The image analysis computer 108 can then find the largest group or if all contours are in different groups, find the y-range of contour with max height.

In some embodiments, the image analysis computer 108 can perform a column majority vote process to modify the barcodes to clean up the barcode images. The image analysis computer 108 can calculate the number of white pixels in each column (e.g., a 1 pixel width column in the image). The image analysis computer 108 can set the value in the output array based on the majority vote. The image analysis computer 108 can create a new image based on the column majority vote. For example, if a column has more white pixels than black pixels, then the image analysis computer 108 can modify each pixel in the column to be white. If a column has more black pixels than white pixels, then the image analysis computer 108 can modify each pixel in the column to be black.

The image analysis computer 108 can also verify the sizes of the bars and the gaps between the bars of the barcodes. The image analysis computer 108 can determine the bar widths and the gap widths. The image analysis computer 108 can sum the pixel values along the vertical axis, loop through the transitions from white to black and vice versa and calculate the bar/gap width. The image analysis computer 108 can utilize the bar widths and the gap widths to verify that the reconstructed barcode matches one or more standards for creating barcodes. For example, the image analysis computer 108 can verify that the barcode is itl2of5. The image analysis computer 108 can verify any suitable type of barcode (e.g., UPC, EAN, CODE 39, CODE 128, ITF, CODE 93, Codabar, Databar, etc.).

At step 324, the image analysis computer 108 can output the modified machine readable code(s).

In some embodiments, the image analysis computer 108 can store one or more modified machine readable codes from the image data in association with the image data in the image database 106. For example, after processing the image data, the image analysis computer 108 can generate an item information data entry that includes the modified machine readable code. The image analysis computer 108 can store the item information data entry into the item information database 110.

The item information database 110 can store item information data entries for items that are provided by service providers to end users via transporters. The item information database 110 can store a plurality of item identifiers (e.g., item name, item number, etc.) along with modified machine readable codes.

The modified machine readable codes can then be used in a number different ways. For example, when an image of a shelf unit in a store is taken by a user (e.g., a transporter or a store employee), images of item tags with machine readable codes and their corresponding items are in the images. The modified machine readable codes can be created (e.g., using a local or remote computer) according to the embodiments described with respect to FIG. 3. The modified machine readable codes can then be decoded to identify data such as the names of the items on the shelves. The image may also show the number of items or the presence or non-presence of those items corresponding to those item tags. A computer (e.g., a remote server computer) can then determine how many of a particular item may be present on the shelf unit, or if the particular item is present or not present on the shelf unit. This can be used to take further action. For example, a store manager may order more of a particular item if it is out of stock on the shelf unit. In another example, the computer may inform a delivery or purchase platform about whether or not an item is in stock or not in stock. The delivery or purchase platform can then modify its display of items for sale to indicate whether items are or are not in stock, and possibly the quantity of such items if they are in stock.

In embodiments of the invention, morphology is a set of image processing operations that process images based on shapes. Morphological operations can apply a structuring element to an input image, creating an output image of the same size. In a morphological operation, the value of each output pixel in the output image is based on a comparison of the corresponding input pixel in the input image with the input pixel's neighboring pixels.

A structuring element can be a matrix that defines the neighborhood used to process each pixel in the input image. The center pixel of the structuring element, referred to as the origin, identifies the input pixel in the input image being processed. A structuring element can be selected so that it is of the same size and shape as the objects that are being evaluated in the input image. For example, to find lines in an image, the structuring element can be a linear structuring element.

There can be two types of structuring elements: flat and nonflat. A flat structuring element is a binary valued neighborhood, either 2-D or multidimensional, in which the true (1-valued) pixels are included in the morphological operation, and the false (0-valued) pixels are not. A strel function can be used to create a flat structuring element. Flat structuring elements can be utilized with both binary and grayscale images, whereas nonflat structuring elements can only be utilized with grayscale images. A nonflat structuring element includes an additive offset for each pixel in the neighborhood. Pixels in the neighborhood that have a finite real value can be used in the morphological operation. Pixels in the neighborhood with the value negative infinity are not used in the operation.

FIG. 7 shows images illustrating example morphological operations according to embodiments. FIG. 7 illustrates five images illustrating example morphological operations from advanced morphological operation (MORPH_OPEN from OpenCV). FIG. 7 includes an original image 702, an erosion operation 704, a dilation operation 706, an opening operation 708, and a closing operation 710.

The original image 702 includes pixels that have a value of either 0 (e.g., black) or 1 (e.g., white).

The erosion operation 704 shows an image that includes the pixels of the original image 702 after being modified using an erosion morphological operation. The dilation operation 706 shows an image that includes the pixels of the original image 702 after being modified using a dilation morphological operation.

The dilation operation 706 can add pixels to the boundaries of objects in an image, while the erosion operation 704 removes pixels on object boundaries. The number of pixels added or removed from the objects in an image depends on the size and shape of the structuring element used to process the original image 702. In the morphological dilation operation 706 and the erosion operation 704, the state of any given pixel in the output image is determined by applying a rule to the corresponding pixel and its neighbors in the input image. The rule used to process the pixels defines the operation as a dilation or an erosion.

As an illustrative example, the erosion operation 704 can include the following rules for modifying the original image 702. A value of an output pixel is the minimum value of all pixels in the neighborhood of an input pixel. In a binary image (e.g., black and white), an output pixel is set to 0 if any of the neighboring pixels have the value 0. Morphological erosion can remove floating pixels and thin lines so that only substantive objects remain. Remaining lines appear thinner, and shapes appear smaller.

The opening operation 708 shows an image that includes the pixels of the original image 702 after being modified using an opening morphological operation. The closing operation 710 shows an image that includes the pixels of the original image 702 after being modified using a closing morphological operation. Dilation operations and erosion operations can be utilized in combination to implement image processing operations.

For example, the opening operation 708 can include eroding the original image 702 and then dilating the eroded image, using the same structuring element for both operations. Morphological opening can be useful for removing small objects and thin lines from an image while preserving the shape and size of larger objects in the image.

As another example, the closing operation 710 can include dilating the original image 702 and then eroding the dilated image, using the same structuring element for both operations. Morphological closing can be useful for filling small holes in an image while preserving the shape and size of large holes and objects in the image.

In some embodiments, the image analysis computer 108 can perform an erosion morphological operation and then a dilation morphological operation (e.g., to perform an opening operation) on the machine readable code image. Performing the erosion operation and then the dilation operation can allow the image analysis computer 108 to remove extraneous pixels of information (e.g., remove black pixels) that are not directly related to the machine readable code (e.g., barcode, QR code, etc.).

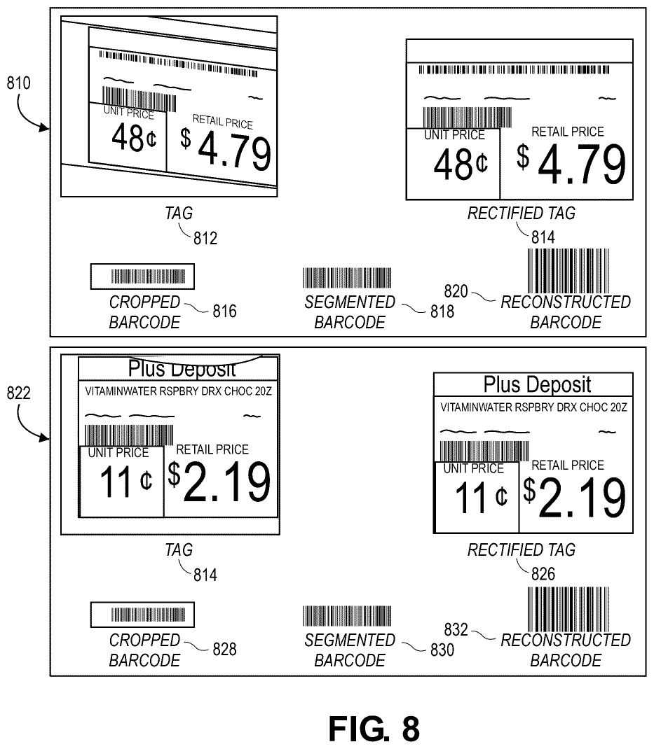

FIG. 8 shows images illustrating machine readable code reconstruction according to embodiments. FIG. 8 includes a first example 810 and a second example 822 of generating a reconstructed machine readable code from an image of an item tag.

The first example 810 includes an item tag 812. The image analysis computer 108 can rectify the item tag 812 to obtain the rectified item tag 814. The image analysis computer 108 can then identify and crop out the machine readable code from the rectified item tag 814 to obtain the cropped machine readable code 816. The image analysis computer 108 can segment the machine readable code in the image of the cropped machine readable code 816 to obtain the segmented machine readable code 818. The image analysis computer 108 can then modify the segmented machine readable code 818 to obtain the reconstructed machine readable code 820.

The second example 822 includes an item tag 824. The image analysis computer 108 can rectify the item tag 824 to obtain the rectified item tag 826. The image analysis computer 108 can then identify and crop out the machine readable code from the rectified item tag 826 to obtain the cropped machine readable code 828. The image analysis computer 108 can segment the machine readable code in the image of the cropped machine readable code 828 to obtain the segmented machine readable code 830. The image analysis computer 108 can then modify the segmented machine readable code 830 to obtain the reconstructed machine readable code 832.

FIG. 9 shows a system 900 according to embodiments of the disclosure. The system of FIG. 9 includes a central server computer 902, a logistics platform 904, an end user device 906, an end user 908, a pickup location 910, a drop-off location 912, a transporter user device 914, a transporter 916, a navigation network 920, a service provider computer 922, the image database 106, the image analysis computer 108, and the item information database 110.

The central server computer 902 can be in operative communication with the logistics platform 904, the end user device 906, the transporter user device 914, the navigation network 920, the service provider computer 922, the image database 106, and the item information database 110. The transporter user device 914 can be in operative communication with the navigation network 920. The image database 106 can be in operative communication with the image analysis computer 108, which can be in operative communication with the item information database 110.

For simplicity of illustration, a certain number of components are shown in FIG. 9. It is understood, however, that embodiments of the invention may include more than one of each component. In addition, some embodiments of the invention may include fewer than or greater than all of the components shown in FIG. 9. For example, although FIG. 9 shows one transporter 916, there can be two, three, or more transporters, transporter user devices, etc.

Messages between the devices and the computers in the system 900 in FIG. 9 can be transmitted using a secure communications protocols as described herein.

The central server computer 902 can be the server computer 104. The central server computer 902 can include a computer that can facilitate in the fulfillment of fulfillment requests received from the end user device 906. For example, the central server computer 902 can identify the transporter 916 (from among many candidate transporters) operating the transporter user device 914 as being suitable for satisfying the fulfillment request. The central server computer 902 can identify the transporter user device 914 that can satisfy the fulfillment request based on any suitable criteria (e.g., transporter location, service provider location, end user destination, end user location, transporter mode of transportation, etc.).

The central server computer 902 can receive data relating to a delivery order of items from the service provider computer 922 to the end user 908 at the drop-off location 912. The central server computer 902 can determine a route for delivery of the delivery order. The central server computer 902 can present the routes to a plurality of transporter user devices and/or transporters. The central server computer 902 can receive acceptances from the transporter 916 that will deliver the items from the pickup location 910 to the drop-off location 912.

The central server computer 902 can receive image data from user devices. For example, the central server computer 902 can receive image data from the transporter user device 914. The central server computer 902 can also receive image data from the end user device 906. The central server computer 902 can store the image data into the database 124.

The central server computer 902 can maintain and update item listings that can be accessible in a delivery application managed by the central server computer 902. The delivery application can be installed on end user devices and can allow end users to select items from the item listings to have delivered to the end user from a service provider location by a transporter. The central server computer 902 can update item listings based on item information data entries in the item information database 110.

In some embodiments, the central server computer 902 can maintain and update item listings on the delivery application using modified machine readable codes from the item information database 110 as well as inventory information provided from the service provider computer 922. For example, the item information database 110 can indicate that a particular item has been identified using a modified machine readable code from an image captured at the service provider location. The central server computer 902 can update the item listing for the particular item based on the information from the item information database 210.

The logistics platform 904 can include a location determination system, which can determine the locations of various user devices such as transporter user devices (e.g., the transporter user device 914) and end user devices (e.g., the end user device 906). The logistics platform 904 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 904 can be part of the central server computer 902 or can be a system that is separate from the central server computer 902.

The end user device 906 can include a device operated by the end user 908. The end user devices 906 can generate and provide fulfillment request messages to the central server computer 902. The fulfillment request message can indicate that the request (e.g., a request for a service) can be fulfilled by the service provider computer 922. For example, the fulfillment request message can be generated based on a cart selected at checkout during a transaction using a central server computer application installed on the end user device 906. The fulfillment request message can include one or more items from the selected cart.

The end user device 906 can provide a fulfillment request message to the central server computer 902 that indicates that the end user device 906 is requesting that the transporter 916 pickup an item from the pickup location 910 (e.g., end user's 908 location) and deliver the item to the drop-off location 912 (e.g., the service provider computer's 922 location).

The pickup location 910 can be a location in which items are stored. In the context of an outbound delivery from an end user at an end user location, examples of the pickup location 910 may be a house or an apartment, a mailbox, a service provider location (e.g., a retail store, a grocery store, a dry cleaning store), a pickup hub, etc. Items can first be obtained from a pickup location 910 and then be transported to the drop-off location 912. Examples of the drop-off location 912 can be similar to the pickup location 910, such as a house or apartment, a mailbox, a retail store, a grocery store, a dry cleaning store, a pickup hub, etc. In one example, the pickup location 910 can be a pizza parlor from which the end user 908 orders a pizza. The drop-off location 912 can be an apartment in which the end user 908 resides.

The transporter user device 914 can include a device operated by the transporter 916. The transporter user device 914 can include a smartphone, a wearable device, a personal assistant device, etc. The transporter 916 can accept an end user's fulfillment request via an acceptance message. For example, the transporter user device 914 can generate and transmit a request to fulfill a particular end user's fulfillment request to the central server computer 902. The central server computer 902 can notify the transporter user device 914 of the fulfillment request. The transporter user device 914 can respond to the central server computer 902 with a request to perform the delivery to the end user as indicated by the fulfillment request.

In some embodiments, the transporter 916 can be an operator of a vehicle. In other embodiments, the transporter 916 can be a vehicle that can be operated by an operator or can be autonomous. The vehicle can include a car, a truck, a van, a motorcycle, a bicycle, a drone, or other vehicle.

The navigation network 920 can provide navigational directions to the transporter user device 914. For example, the transporter user device 914 can obtain a location from the central server computer 902. The location can be a service provider parking location, a service provider location, an end user parking location, an end user location, etc. The navigation network 920 can provide navigational data to the location. For example, the navigation network 920 can be a global positioning system that provides location data to the transporter user device 914.

The service provider computer 922 include computers operated by a service provider. For example, the service provider computer 922 can be a food provider computer that is operated by a food provider. The service provider computer 922 can offer to provide services to the end user 908 of the end user device 906. In embodiments of the invention, the service provider computer 922 can receive requests to prepare one or more items for delivery from the central server computer 902. The service provider computer 922 can initiate the preparation of the one or more items that are to be delivered to the end user 908 of the end user device 906 by the transporter 916 of the transporter user device 914.

Embodiments of the disclosure have a number of advantages. For example, embodiments provide technical advantages of being able to extract highly accurate item details (e.g., machine readable code data, names, prices, etc.) using an image of a shelf unit. The systems and methods herein do not rely on specific hardware that is required to capture the images, such as was done in previous methods (e.g., using a handheld barcode scanner).

Embodiments provide for a number of additional advantages. For example, embodiments allow for multiple machine readable codes to be scanned at a time using a single image of the shelfing unit rather than needing to scan each machine readable code individually, thus reducing the time spent scanning. For example, an image analysis computer can identify a plurality of barcodes in a single image, thus greatly increasing scanning speed compared using the handheld barcode scanner.

Furthermore, embodiments provide for technical advantages over previous uses of machine learning models that simply attempt to determine a machine readable code from an image. Embodiments improve the accuracy of the readability of each barcode in an image by modifying segmented machine readable codes from the overall image. As such, modified machine readable codes, according to embodiments, have a lower failure rate when being utilized to identify an item.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, image data of an image of a shelf unit with specific items and item tags comprising machine readable codes adjacent to the specific items;
identifying, by the computer, the item tags in the image data;
identifying, by the computer, machine readable codes in one or more item tags in the image data;
resizing, by the computer, the machine readable codes in the image data so that the machine readable codes are a same size;
thresholding, by the computer, each pixel in the machine readable codes;
after thresholding, performing, by the computer, a morphological operation on the machine readable codes;
after performing the morphological operation, adjusting, by the computer, sizes of features of the machine readable codes; and
after adjusting sizes, outputting, by the computer, modified machine readable codes.

2. The method of claim 1, wherein after identifying the item tags in the image data, the method further comprises:
segmenting, by the computer, the item tags from the image data; and
rectifying, by the computer, the item tags.

3. The method of claim 1 further comprising:
after performing the morphological operation, performing a majority vote process on each column of pixels in each machine readable code.

4. The method of claim 1, wherein after identifying the machine readable codes, the method further comprises:
segmenting, by the computer, the machine readable codes from the item tags; and
rectifying, by the computer, the machine readable codes.

5. The method of claim 1, wherein performing the morphological operation on the machine readable codes comprises:
performing, by the computer, an erosion morphological operation on the machine readable codes; and
performing, by the computer, a dilation morphological operation on the machine readable codes.

6. The method of claim 1, wherein the machine readable codes are barcodes, wherein the sizes of features include vertical lengths of each bar of the barcodes, and wherein adjusting the sizes of features of the machine readable codes comprises:
modifying, by the computer, the vertical length of each bar of the barcodes to be a same length.

7. The method of claim 1, wherein resizing the machine readable codes in the image data comprises:
resizing, by the computer, the machine readable codes in the image data to a predetermined pixel height and a predetermined pixel width.

8. The method of claim 1 further comprising:
after outputting the modified machine readable codes, storing, by the computer, the modified machine readable codes in an item information database, wherein a server computer obtains the modified machine readable codes from the item information database and updates a delivery application using the modified machine readable codes.

9. The method of claim 1, wherein identifying the item tags in the image data comprises:
identifying, by the computer, using a machine learning model trained to identify item tags, wherein the machine learning model is a single-shot detector object detection machine learning model.

10. The method of claim 1, wherein the image data is received from an image database, wherein a user device captures the image data at a service provider location and provides the image data to a server computer, wherein the server computer stores the image data in the image database.

11. The method of claim 1, wherein thresholding each pixel in the machine readable codes comprises:
for each pixel, comparing, by the computer, a value of the pixel to a threshold value to categorize the pixel as being black or white.

12. The method of claim 1, wherein the machine readable codes include barcodes or QR codes, and wherein the computer is an image analysis computer.

13. A computer comprising:
a processor; and
a computer-readable medium coupled to the processor, the computer-readable medium comprising code executable by the processor for implementing a method comprising:
receiving image data of an image of a shelf unit with specific items and item tags comprising machine readable codes adjacent to the specific items;
identifying the item tags in the image data;
identifying machine readable codes in one or more item tags in the image data;
resizing the machine readable codes in the image data so that the machine readable codes are a same size;
thresholding each pixel in the machine readable codes;
after thresholding, performing a morphological operation on the machine readable codes;
after performing the morphological operation, adjusting sizes of features of the machine readable codes; and
after adjusting sizes, outputting modified machine readable codes.

14. The computer of claim 13, wherein the method further comprises:
determining item identifiers and item data using the modified machine readable codes.

15. The computer of claim 13, wherein identifying the machine readable codes in the one or more item tags in the image data comprises:
identifying using a machine learning model trained to identify machine readable codes, wherein the machine learning model is a single-shot detector object detection machine learning model.

16. The computer of claim 15, wherein the method further comprises:
obtaining a first plurality of images of item tags that include machine readable codes from a database;
creating a first training set comprising the first plurality of images;
training the machine learning model using the first training set to identify the machine readable codes in the first plurality of images;
obtaining a second plurality of images of item tags that include machine readable codes from the database;
creating a second training set comprising the second plurality of images; and
training the machine learning model using the second training set to identify the machine readable codes in the second plurality of images.

17. The computer of claim 13, wherein the computer is an image analysis computer, wherein the computer further comprises:
an image element detection module; and
an image processing module.

18. A method comprising:
receiving, by a server computer from a user device, image data of an image of a shelf unit with specific items and item tags comprising machine readable codes adjacent to the specific items;
storing, by the server computer, the image data in an image database, wherein an image analysis computer obtains the image data from the image database, identifies the item tags in the image data, identifies machine readable codes in one or more item tags in the image data, thresholds each pixel in the machine readable codes, performs a morphological operation on the machine readable codes, adjusts sizes of features of the machine readable codes, determines modified machine readable codes, and stores the modified machine readable codes in an item information database;
obtaining, by the server computer, the modified machine readable codes from the item information database; and
updating, by the server computer, an application maintained by the server computer using the modified machine readable codes.

19. The method of claim 18, wherein the server computer is a central server computer, wherein the user device is a transporter user device, wherein the machine readable codes include barcodes or QR codes, and wherein the application is a delivery application.

20. The method of claim 18 further comprising:
identifying, by the server computer, items associated with the modified machine readable codes using the modified machine readable codes.
